(19) United States
(12) Patent Application Publication
(10) Pub. No.: US 2010/0125619 A1
(43) Pub. Date: May 20, 2010

(54) DETERMINISTIC SELECTION OF DOMAIN CONTROLLERS IN A MULTI-MASTER DATABASE DISTRIBUTED DIRECTORY SERVICE

(75) Inventors: Juan Diego Ferre, Seattle, WA (US); Mihai Roman Jalobeanu, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/274,350

(22) Filed: Nov. 20, 2008

(51) Int. Cl. G06F 17/30

(52) U.S. Cl. 707/828; 707/E17.032

(57) ABSTRACT

Data is maintained that identifies the available domain controllers for performing management actions with respect to a distributed directory service database. When a request is received to perform a management action on a directory service database object, the particular domain controller that is to perform the management action, called the master domain controller, is selected deterministically. Once the master domain controller has been identified, a request to perform the management action is transmitted to the master domain controller. The failure of a master domain controller will cause the identification of that domain controller to be removed from the data that identifies the available domain controllers and a deterministic failover to be performed to another master domain controller.

### BACKGROUND

A directory service stores information about networks and domains and provides access to this information to users and administrators. A directory service may also provide functionality for assigning policies, deploying software, authentication and other types of security mechanisms, domain name services, and other types of network services. A directory service typically maintains a database for storing the directory information.

A distributed directory service utilizes a distributed multi-master database. In a distributed multi-master database directory service, changes made to the directory database maintained by one domain controller are replicated to copies of the database maintained by other domain controllers. There may be a time delay, referred to herein as “replication latency”, between the time data is written by one domain controller and the time at which the data is replicated to other domain controllers.

Applications can extend and utilize the database maintained by a directory service to store information. For instance, a personal information manager (“PIM”) server application might use a distributed directory service to store data regarding usernames and electronic mail (“e-mail”) addresses. The actual PIM data, such as mailboxes, calendar data, and the like, is stored by the PIM server application in its own database. A server application might provide a user interface for performing management actions against the distributed directory database. Alternately, another management application might provide a suitable user interface for performing management actions against the directory database.

In some network installations, neither the server applications nor the domain controllers within a network forest are directly addressable. For instance, a uniform resource locator (“URL”) of the forest may resolve to a load-balancing device that selects one of several available server application instances. In this scenario, a management action is executed by a server application chosen essentially at random. In order to perform the management action, the chosen server application then communicates with one or more domain controllers that are also chosen essentially at random. As a result, the selection of a server application instance and a domain controller for performing a management action is non-deterministic.

Due to the non-deterministic selection of domain controllers and the replication latency inherent in a multi-master database distributed directory service, management actions may fail that are performed against an object at a domain controller to which changes have not yet been replicated. For instance, a management action to create a new e-mail mailbox may be performed by a server application against a first domain controller. If a second management action is subsequently performed by another server application against the newly created mailbox at a second domain controller to which the newly created mailbox has not yet been replicated, the operation will fail. This type of unpredictability in the performance of management actions can be extremely frustrating for system administrators.

It is with respect to these considerations and others that the disclosure made herein is presented.

### SUMMARY

Technologies are described herein for deterministically selecting domain controllers in a multi-master distributed directory service. In particular, through the utilization of the concepts and technologies presented herein, the domain controller to be utilized to perform a management action on a directory object is selected deterministically. As a result, the same domain controller will be utilized to perform all management actions with respect to the same object, thereby eliminating the possibility that another domain controller will subsequently attempt to perform a management action on the same object and fail due to replication latency. In this way, a multi-master database distributed directory service is treated as a single-master database system.

In one implementation, data is maintained that identifies the available domain controllers for performing management actions with respect to a distributed directory service database. When a request is received to perform a management action on a directory service database object (an “object”), the particular domain controller that is to perform the management action, referred to herein as the “master domain controller,” is selected deterministically.

In one embodiment, a property of the object upon which the management action is to be performed is deterministically transformed into data identifying the master domain controller. Once the master domain controller has been identified, a request to perform the management action is transmitted to the master domain controller. Because each application that utilizes domain controllers to perform management actions selects a master domain controller utilizing the same deterministic transformation, it is guaranteed that the same domain controller will perform all management actions for the same object.

In other implementations, the failure of a master domain controller will cause the identification of that domain controller to be removed from the data that identifies the available domain controllers. As a consequence, a deterministic failover is performed to another master domain controller. This change is observed by all applications that utilize domain controllers to perform management actions on distributed directory service data.

In one embodiment, the deterministic transformation includes hashing the property of the object upon which the management action is to be performed to the available domain controllers. In an embodiment wherein multiple tenants may utilize the services of applications and domain controllers within a domain, the property utilized identifies a database tenant. For instance, the property may identify a domain name corresponding to a particular tenant. In this way, management actions on objects maintained by the distributed database service may be partitioned according to database tenants. Objects stored in the distributed directory service database that are created or modified as a result of a management action will be subsequently replicated to the other domain controllers. Replication latency will not cause subsequent management actions performed with respect to the same object to fail because the same domain controller that handled the original request is guaranteed to also handle the subsequent management actions.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of a distributed directory service that forms one illustrative operating environment for the embodiments presented herein;

FIG. 2 is a network diagram showing aspects of the operation of an application management tool and a server application in a distributed directory service;

FIG. 3 is a network diagram showing aspects of the operation of an application management tool and a server application according to one embodiment presented herein;

FIG. 4 is a software architecture diagram showing aspects of one illustrative process presented herein for deterministically transforming an object property into data identifying a master domain controller in one embodiment;

FIG. 5 is a flow diagram showing one illustrative process for the deterministic selection of a domain controller according to one embodiment presented herein; and

FIG. 6 is a computer architecture diagram showing an illustrative computer hardware and software architecture for a computing system capable of implementing aspects of the embodiments presented herein.

### DETAILED DESCRIPTION

The following detailed description is directed to concepts and technologies for deterministically identifying a domain controller in a multi-master distributed directory service. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks, implement particular abstract data types, and transform data. Moreover, those skilled in the art will appreciate that the subject matter described herein may be practiced with or tied to other specific computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, technologies for deterministically selecting a domain controller will be described.

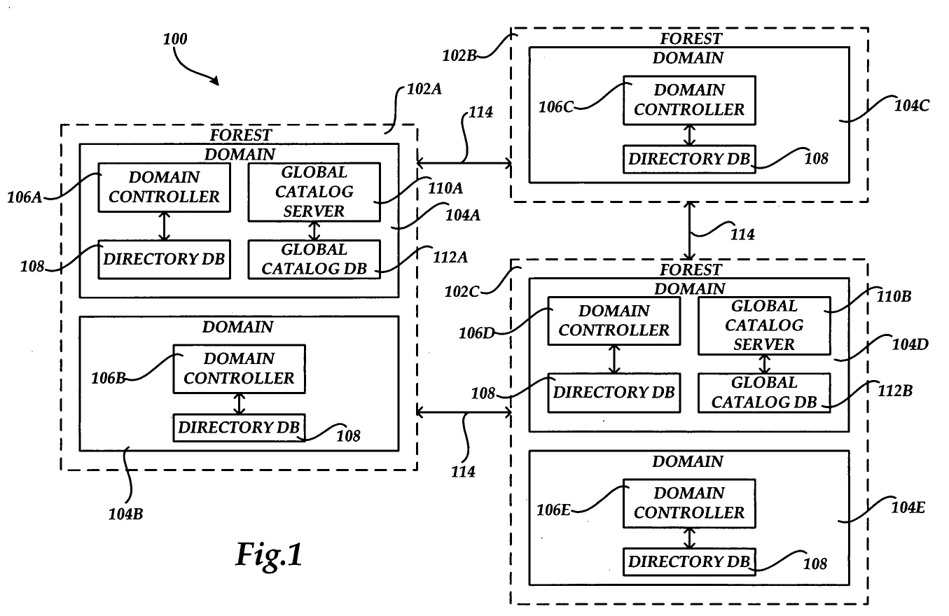

Turning now to FIG. 1, details will be provided regarding an illustrative operating environment for the embodiments presented herein. In particular, FIG. 1 shows aspects of a multi-master database distributed directory service 100 (the “directory service”) that forms an operating environment for embodiments presented herein. The directory service 100 enables the centralized, secure management of an entire network, which might span a building, a city, or multiple geographic locations. In particular, the directory service 100 serves as a repository of information and a set of integrated services that together provide the means to manage network users, services, devices, and additional information that system administrators would like to store.

According to embodiments, the directory service 100 provides a centralized location to store information about users, devices, services, networks, forests 102A-102C, and domains 104A-104C, and provides access to this information to users, administrators, computers, and applications. The directory service 100 also provides functionality to securely add, modify, delete, and retrieve information in the directory database 108. The directory service 100 may also provide functionality for assigning policies, deploying software, authentication and other types of security mechanisms, domain name services, and other types of network services.

In one implementation, the directory service 100 utilizes a multi-master database system to store directory data in a distributed fashion. In such a distributed multi-master database system, changes made to a copy of the directory database 108 maintained by one domain controller are synchronized to copies of the database 108 maintained by other domain controllers. For instance, changes to the copy of the database 108 maintained by the domain controller 106A are periodically replicated to copies of the database 108 maintained by the domain controllers 106B-106E. Due to network and processing latencies, there may be a time delay, referred to herein as “replication latency”, between the time data is written by one domain controller and the time at which the data is replicated to other domain controllers.

According to embodiments, the directory service 100 may utilize one or more global catalog servers 110A-110B. The global catalog servers 110A-110B maintain directory data for domains across an entire forest 102A-102B in the global catalog databases 112A-112B, respectively. The domain controllers 106A-106D typically only maintain directory data for the domain 104A-104E in which they are active. For instance, in the illustrative directory service 100 illustrated in FIG. 1, the global catalog server 110A may store directory data for domain 104A and the domain 104B. The global catalog servers 110A-110B make it possible for clients to search the directory service 100 without having to be referred from server to server until the domain controller 106A-106D that has the domain that stores the requested object is found.

The illustrative directory service 100 illustrated in FIG. 1 includes five domains 104A-104E. The domains 104A-104B have been grouped into a forest 102A, the domain 104C is in the forest 102B, and the domains 104D-104E are within the forest 102C. Each of the forests 102A-102C is connected via appropriate network communications links 114. It should be appreciated that the directory service 100 illustrated in FIG. 1 is merely illustrative and that a virtually infinite number of configurations may be implemented depending upon the particular application and network topography being utilized. It should also be appreciated that many more computing systems and network connections 114 may be utilized than shown in FIG. 1 to enable the operation of the directory service 100 described herein.

According to one embodiment, the directory service 100 is implemented utilizing the ACTIVE DIRECTORY directory service from MICROSOFT CORPORATION of Redmond, Wash. It should be appreciated, however, that the embodiments presented herein may be utilized with other directory services from other vendors, such as the SUN JAVA SYSTEM DIRECTORY SERVER ENTERPRISE EDITION directory service from SUN MICROSYSTEMS or the eDIRECTORY directory service from NOVELL, INC.

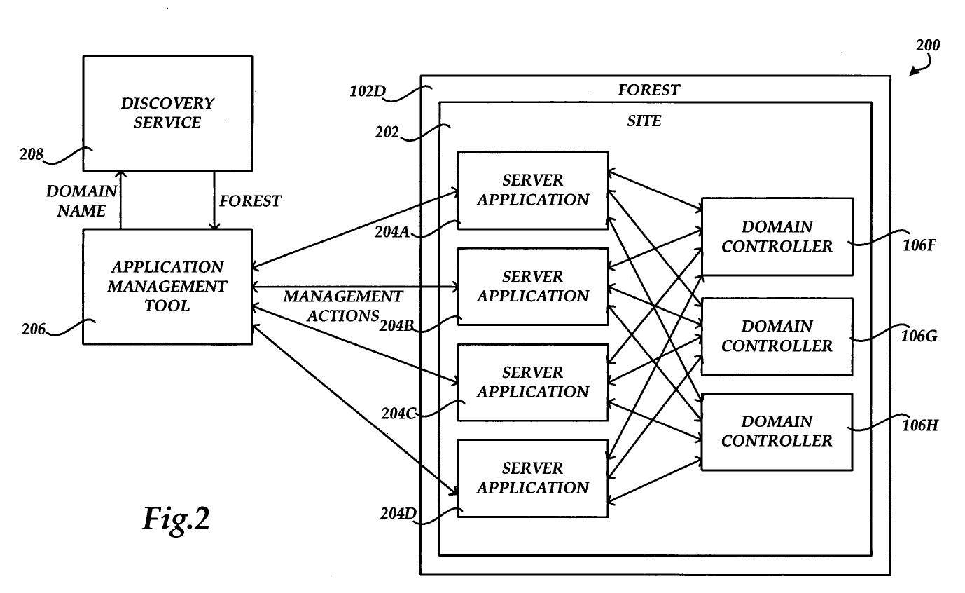

In one embodiment, applications can extend the database schema utilized by the directory service 100 and utilize the database 108 maintained by the directory service 100 to store information. For instance, a PIM server application might use the distributed directory service 100 to store data regarding usernames and e-mail addresses. The actual PIM data, such as mailboxes, calendar data, and the like, is stored by the PIM server application in its own database. A server application might also provide a user interface for performing management actions against the distributed directory database 108. Alternately, another management application might provide a suitable user interface for performing management actions against the directory database 108. Additional details regarding the utilization of the directory service 100 by a server application will be provided below with respect to FIGS. 2-5.

Turning now to FIG. 2, additional details will be provided regarding the use of the directory service 100 by one or more server applications 204A-204D. In particular, FIG. 2 shows a system 200 that includes a multi-master distributed directory service, such as the directory service 100 described above. In this regard, the illustrative system 200 includes the domain controllers 106F-106H that are located at the same network site 202 within the forest 102D.

As also shown in FIG. 2, several server applications 204A-204D are configured at the site 202 to utilize the domain controllers 106F-106H to store application data in the directory database 108. The URL of the forest 102D may resolve to a load-balancing device (not shown) that selects one of the server applications 102A-102D for performing management actions and processing and responding to application client requests. As used herein, the term “management action” refers to any administrative action performed with respect to objects stored in the directory database 108. For instance, management actions include, but are not limited to, requests to create a new object or to modify an existing object in the directory database 108.

According to one implementation, an application management tool 206 is provided that is configured to provide a user interface and associated functionality for managing the operation of the server applications 204A-204D. The application management tool 206 may be provided by the server application 204 in one embodiment or may be a software component executing separately from the server application 204. For instance, in one implementation the application management tool 206 comprises the POWERSHELL command line shell and associated scripting language from MICROSOFT CORPORATION. The application management tool 206 may obtain the network location of the forest 102D through a discovery service 208. The discovery service 208 takes a domain name as input and returns a URL or network address of the forest 102D corresponding to the provided domain name.

Through the use of the application management tool 206, instructions can be transmitted to the server applications 204A-204D to perform management actions with respect to directory data stored by the domain controllers 106F-106H. As mentioned above, neither the server applications 204A-204D nor the domain controllers 106F-106G within a network forest 102D are directly addressable in some network installations. In these installations, the particular server application 204A-204D that will perform a management action requested by the application management tool 206 is chosen essentially at random. In order to perform the management action, the chosen server application instance then communicates with one of the domain controllers 106F-106H, which is also chosen essentially at random. As a result, the selection of a server application instance and a domain controller for performing a management action is non-deterministic.

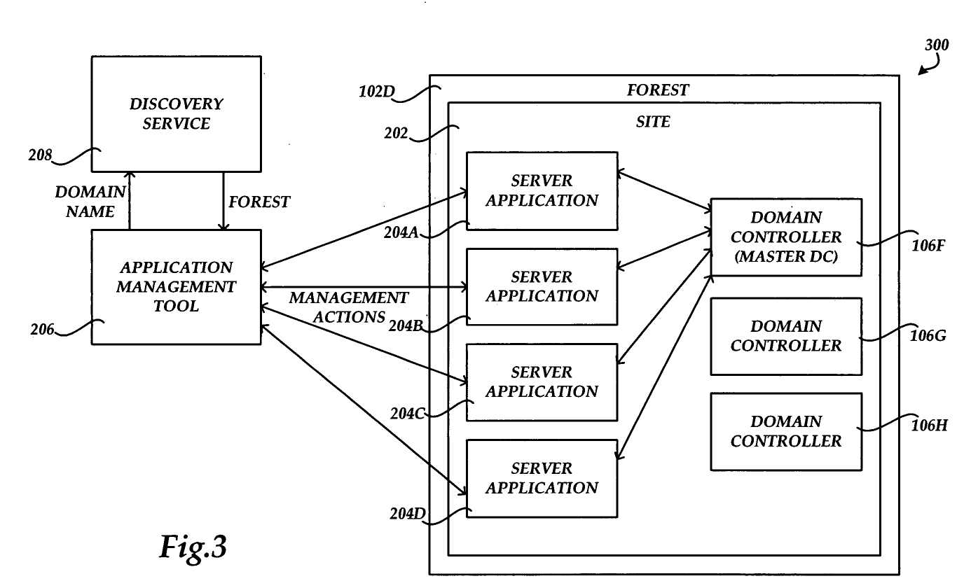

Due to the non-deterministic selection of domain controllers and the replication latency inherent in a multi-master database distributed directory service, management actions may fail that are performed against an object at a domain controller to which changes have not yet been replicated. For instance, a management action to create a new e-mail mailbox may be performed by one of the server application 204A-204D against a first domain controller 106F. If a second management action is subsequently performed by another server application 204A-204D against the newly created mailbox at a second domain controller 106G to which the newly created mailbox has not yet been replicated, the operation will fail. This type of unpredictability in the performance of management actions can be extremely frustrating for system administrators. FIGS. 3-5, discussed below, describe mechanisms for deterministically selecting one of the domain controllers 106F-106H, thereby eliminating the possibility that subsequent management actions performed with respect to the same directory object will fail because the same domain controller that handled the original request is guaranteed to also handle the subsequent management actions.

Referring now to FIG. 3, details will be provided regarding the use of the directory service 100 by one or more server applications 204A-204D in one embodiment provided herein wherein the domain controller 106F-106H that will handle a particular management action is chosen deterministically. In particular, FIG. 3 shows a system 300 that includes a multi-master distributed directory service, such as the directory service 100 described above, that includes three domain controllers 106F-106H, four instances of a server application 204A-204D, and an application management tool 206.

In the embodiment illustrated in FIG. 3, the particular server application 204A-204D instance that will perform a particular management action requested by the application management tool 206 is still chosen essentially at random. However, in this implementation, the server applications 204A-204D are configured to select a domain controller 106F-106H for performing the requested management action deterministically. The term “master domain controller” is used herein to refer to a domain controller that is utilized to perform management actions with respect to a particular directory object.

In one embodiment, a property of the directory object that is being created, modified, or read is transformed in order to identify the master domain controller for the object. In this manner, the same master domain controller will be utilized to perform all management actions with respect to an object (and all other directory objects sharing the same property), thereby eliminating the possibility that another domain controller will subsequently attempt to perform a management action on the same object and fail due to replication latency. In this way, a multi-master database distributed directory service is treated as a single-master database system.

According to one implementation, the server applications 204A-204D comprise PIM server applications. A PIM server application operates in conjunction with a client application to allow a user to store and access e-mail messages, calendar items, contacts, and other personal information. In this embodiment, the PIM server applications 204A-204D utilize the distributed directory service to store data. For instance, a PIM server application might use the distributed directory service to store data regarding usernames and e-mail addresses. The actual PIM data, such as mailboxes, calendar data, and the like, is stored by the PIM server application in its own database. In one specific implementation, the server applications 204A-204D comprise instances of the EXCHANGE PIM server application from MICROSOFT CORPORATION. Other types of PIM server applications may also be utilized with the embodiments presented herein.

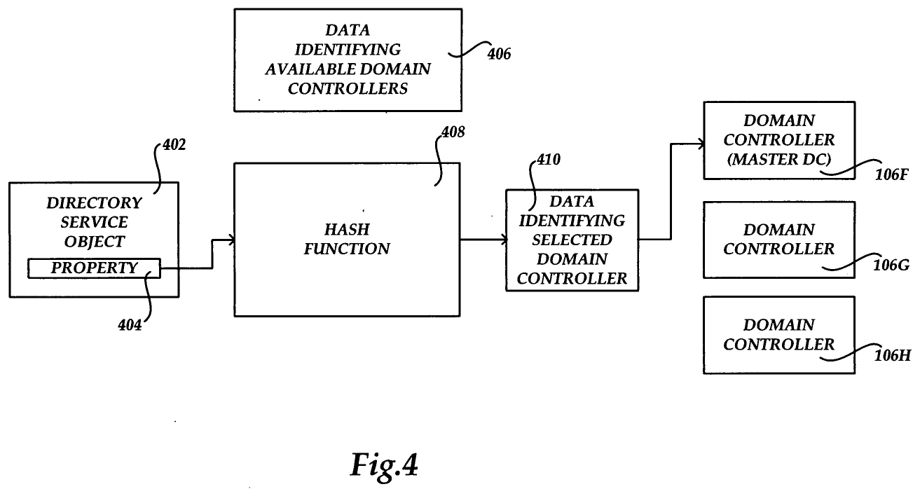

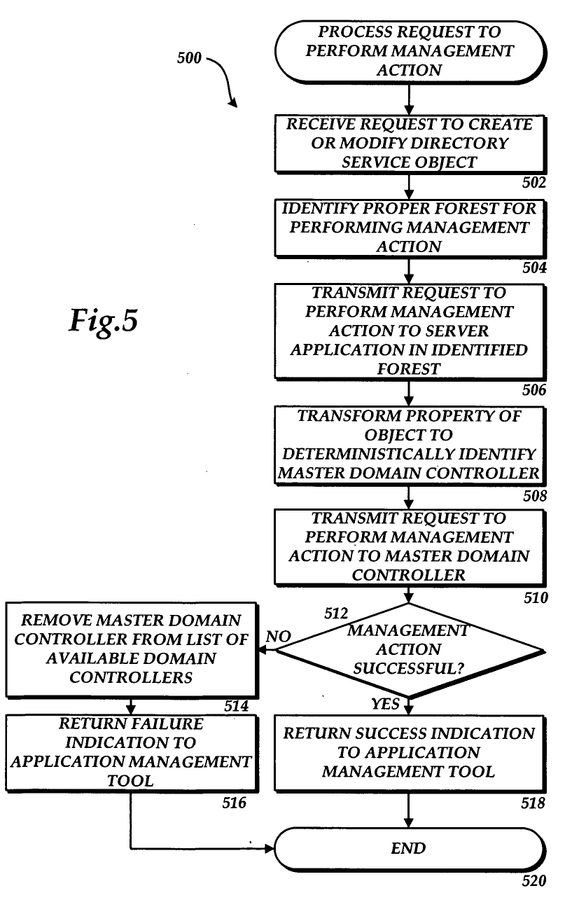

In an embodiment, the server applications 204A-204D may be utilized to provide PIM services to multiple tenants. For instance, the same group of server applications 204A-204D may be utilized to provide PIM services like e-mail to multiple different organizations, each using a different domain name. In this implementation, the property of a directory object that is utilized to identify a master domain controller is a property that identifies a database tenant. For instance, a property that is utilized to store a domain name for a particular tenant of the system 300 will be utilized to identify the particular domain controller 106F-106H that should be utilized as the master domain controller. As an example, a directory object that pertains to an e-mail mailbox will include a property that identifies the domain name of the database tenant that owns the mailbox. In this way, the same domain controller will perform all management actions for directory objects corresponding to the same tenant. Additional details regarding this process will be provided below with respect to FIGS. 4-5.

Turning now to FIG. 4, additional details will be provided regarding one process provided herein for deterministically identifying a master domain controller for a directory object 402. As discussed above, a property 404 of a directory object 402 upon which a management action is to be performed is transformed in one embodiment to data 410 that identifies the master domain controller for the object 402. According to one embodiment, this transformation is performed through the use of a hash function 408. In this embodiment, the server applications 204A-204D maintain data 406 that identifies the domain controllers 106F-106H that are available and capable of performing the management action. The hash function 408 transforms the property 404 of the object 402 to data 410 that identifies the master domain controller 106F.

As will be discussed in greater detail below, the failure of a master domain controller 106F will cause the identity of the failed controller to be removed from the data 406 that identifies the available domain controllers. In this way, management actions performed on a directory service object 402 subsequent to the failure of a master domain controller will be assigned to a new master domain controller. In this regard, the hash function 408 maps the property 404 of the object 402 only to the available domain controllers as identified by the data 406. Additional details regarding this process will be provided below with respect to FIG. 5.

Referring now to FIG. 5, additional details will be provided regarding the embodiments presented herein for deterministically selecting a domain controller. In particular, FIG. 5 is a flow diagram illustrating aspects of the operation of the application management tool 206 and the server applications 204A-204D for deterministically identifying a master domain controller.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 500 begins at operation 502, where the application management tool 206 receives a request to perform a management action on a directory service object 402. As discussed above, a management action might include creating a new object or modifying an existing object. In response to receiving such a request, the routine 500 proceeds to operation 504, where the application management tool 206 identifies the proper forest 102 for performing the requested management action. As also discussed above, identification of the proper forest involves the use of the discovery server 208 in one embodiment.

Once the proper forest 102 has been identified, the routine 500 proceeds to operation 506, where the application management tool 206 transmits a request to perform the management action to the identified forest. As discussed above, a load-balancing device may receive the request and forward it to one of the server applications 204A-204D selected at random. The selected server application 204A-204D receives the request to perform the management action and deterministically selects one of the available domain controllers 106F-106H to perform the management action. As discussed above, a hash function is utilized to transform a property of the object upon which the management action is to be performed to the identity of a master domain controller in one embodiment. This occurs at operation 508 of the routine 500.

Once the master domain controller has been identified, a request to perform the management action is transmitted to the identified master domain controller at operation 510. From operation 510, the routine 500 proceeds to operation 512, where the server application 204 that transmitted the request to the master domain controller determines whether an acknowledgement was received from the master domain controller indicating that the management action was performed successfully. If the management action was not performed successfully and the master domain controller is incapable of performing the action, the routine 500 proceeds from operation 512 to operation 514, where the identity of the failed master domain controller is removed from the data 406 identifying the available domain controllers. A failure indication is then returned to the application management tool 206 at operation 516. The management action may be retried any number of times before a failure indication is returned.

If, at operation 512, the server application 204 that transmitted the request to the master domain controller determines that an acknowledgement was received from the master domain controller indicating that the management action was performed successfully, the routine 500 proceeds from operation 512 to operation 518. At operation 518, a success indication is returned to the application management tool 206. From operation 518, the routine 500 proceeds to operation 520, where it ends.

It should be appreciated that the deterministic selection of a domain controller as described herein may be performed with respect to management actions and to client requests for directory service data. In an alternate embodiment, the domain controller for processing client requests may not be selected deterministically. Rather, in one embodiment, all directory service operations for a particular tenant may be restricted to the domain controllers at a particular site. In this way cross-site replication latencies are eliminated for each tenant, changes are almost immediately visible to all tools and all users, and the chance for replication conflicts is minimized.

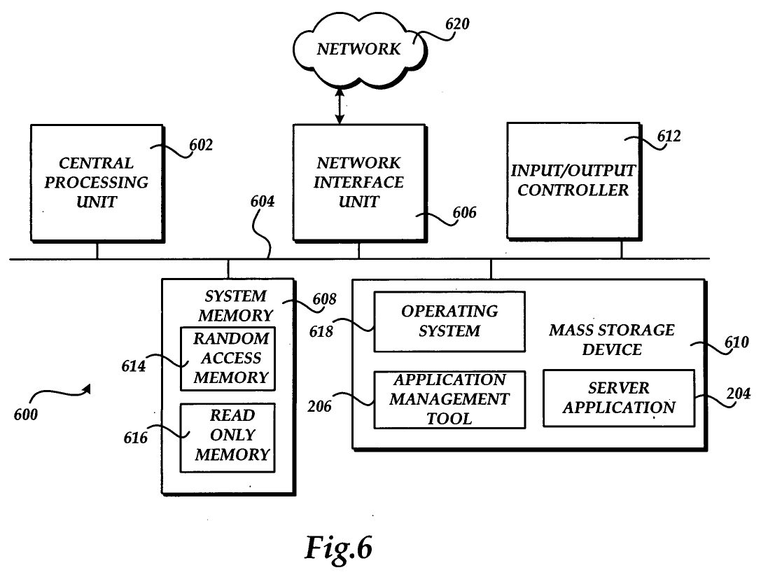

FIG. 6 shows an illustrative computer architecture for a computer 600 capable of executing the software components described herein. The computer architecture shown in FIG. 6 illustrates a conventional desktop, laptop, or server computer and may be utilized to execute any aspects of the software components presented herein.

The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which have been described in greater detail herein.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 620. The computer 600 may connect to the network 620 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system 618 suitable for controlling the operation of a networked desktop, laptop, or server computer. In one embodiment, the operating system 618 includes functionality for implementing the domain controllers 106, described above. The mass storage device 610 and RAM 614 may also store one or more program modules. In particular, the mass storage device 610 and the RAM 614 may store the application management tool 206 and the server application 204, each of which was described in detail above with respect to FIGS. 1-5. The mass storage device 610 and the RAM 614 may also store other types of program modules and data.

Based on the foregoing, it should be appreciated that technologies for deterministically selecting a domain controller are provided herein. Although the subject matter presented herein has been described in language specific to computer structural features, methodological acts that include transformations, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for deterministic selection of a domain controller for performing a management action in a multi-master database distributed directory service, the method comprising:
maintaining data corresponding to one or more domain controllers capable of performing a management action against a distributed directory service database;
receiving a request to perform the management action on a directory service object;
in response to receiving the request, deterministically transforming a property of the directory service object into data identifying a single one of the domain controllers for performing the management action from the one or more domain controllers capable of performing the management action; and
transmitting a request to perform the management action to the single one of the domain controllers identified by the transformation.

2. The method of claim 1, further comprising:
determining that one of the domain controllers is incapable of performing the management action; and
in response to determining that one of the domain controllers is incapable of performing the management action, removing the domain controller that is incapable of performing the management action from the data corresponding to one or more domain controllers capable of performing the management action.

3. The method of claim 1, wherein deterministically transforming a property of the management object into data identifying a single one of the domain controllers for performing the management action from the one or more domain controllers capable of performing the management action comprises performing a hash function on the property of the directory service object thereby transforming the property into the data identifying a single one of the domain controllers for performing the management action.

4. The method of claim 1, wherein the property of the directory service object comprises data identifying a database tenant.

5. The method of claim 4, wherein the data identifying a database tenant comprises a domain name.

6. The method of claim 1, wherein the multi-master database distributed directory service is configured to replicate the directory service object from the single one of the domain controllers identified for performing the management action to the other of the one or more domain controllers.

7. A computer storage medium having computer executable instructions stored thereon which, when executed by a computer, cause the computer to:
maintain data identifying a plurality of domain controllers capable of performing a management action on an object stored by a multi-master database distributed directory service;
receive a request to perform a management action on an object stored in the multi-master database distributed directory service, the object comprising at least one property;
in response to receiving the request to perform the management action, to deterministically transform the property of the object to data identifying a single master domain controller from the plurality of domain controllers for performing the management action; and to
transmit a request to the master domain controller to perform the requested management action.

8. The computer storage medium of claim 7, wherein a server application is configured to receive the request to perform the management action on the object stored in the multi-master database distributed directory service.

9. The computer storage medium of claim 8, wherein the server application comprises a server personal information manager (PIM) server application.

10. The computer storage medium of claim 9, wherein the object comprises an object for storing data pertaining to an electronic mail (e-mail) mailbox.

11. The method of claim 10, wherein the property comprises data identifying a database tenant.

12. The computer storage medium of claim 10, wherein the property comprises a domain name.

13. The computer storage medium of claim 10, wherein deterministically transforming the property of the object to data identifying a single master domain controller from the plurality of domain controllers for performing the management action comprises performing a hash function on the property of the object to identify the master domain controller.

14. The computer storage medium of claim 13, having further computer executable instructions stored thereon which, when executed by the computer, cause the computer to:
determine that the master domain controller is incapable of performing the management action; and
in response to determining that the master domain controller is incapable of performing the management action, to remove the master domain controller from the data corresponding to the plurality of domain controllers capable of performing the management action.

15. A computing system comprising:
a plurality of domain controllers, each of the domain controllers configured to receive and respond to requests from one or more server applications to perform management actions on objects stored in a multi-master distributed directory service; and
a personal information manager (PIM) server application configured to maintain data identifying the plurality of domain controllers available to perform management actions, to deterministically identify a master domain controller from the plurality of domain controllers by transforming a property of an object to data identifying the master domain controller by performing a hash function on the property to identify the master domain controller, and to transmit a request to perform a management action on the object to the one of the plurality of domain controllers identified as the master domain controller.

16. The system of claim 15, wherein the PIM server application is further configured to determine that the master domain controller is incapable of performing the management action and to remove the master domain controller from the data identifying the plurality of domain controllers available to perform management actions in response to determining that the master domain controller is incapable of performing the management action.

17. The system of claim 16, wherein the plurality of domain controllers are configured to replicate the object from the master domain controller to the other of the plurality of domain controllers.

18. The system of claim 17, wherein the object comprises an object for storing data pertaining to an electronic mail (e-mail) mailbox.

19. The method of claim 18, wherein the property of the object comprises data identifying a database tenant.

20. The method of claim 19, wherein the data identifying a database tenant comprises a domain name.
